(19) United States
(12) Patent Application Publication
(10) Pub. No.: US 2010/0063737 A1
(43) Pub. Date: Mar. 11, 2010

(54) 3-DIMENSIONAL DISCRETE DATA RE-SAMPLING METHOD AND DEVICE

(76) Inventors: Tadashi TAKANO, Sagamihara-shi (JP); Takashi Maeda, Sagamihara-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/618,665

(22) Filed: Nov. 13, 2009

Related U.S. Application Data
(63) Continuation of application No. PCT/JP2008/058816, filed on May 14, 2008.

(30) Foreign Application Priority Data
May 14, 2007 (JP) 2007-127716

(51) Int. Cl. G06F 19/00

(52) U.S. Cl. 702/5

(57) ABSTRACT

Provided is a method which selects six points from nine sampling points surrounding a point (x,y)=(X,Y) as a center and estimates a Z-axis value of an arbitrary point in six triangles obtained by the (X,Y) point and the six points. The method selects two points substantially on a diagonal of a rectangle defined by the outermost circumference of the nine points and constitutes the six triangles by the six points excluding the two points.

### FIELD OF THE INVENTION

The present invention relates to a 3-dimensional discrete data re-sampling method and device.

### BACKGROUND ART

A bilinear method and a bicubic method have been used as methods of estimating, on the basis of 3-dimensional discrete data (2-dimensional position data+1-dimensional physical quantity data), the physical quantity data at a certain position between the discrete data, the 3-dimensional discrete data sampled discretely in time and/or space and obtained by a sensor or the like.

However, to employ such methods, points of the 2-dimensional discrete position data obtained by the sensor or the like need to be evenly spaced on the X and Y axes.

Meanwhile, for example, a sensor installed aboard a satellite or an airplane often employs a sampling method of a type in which horizontal-direction scanning is performed at positions forward and obliquely downward in the traveling direction of the satellite or the airplane (see FIG. 1). In this drawing, a sensor traveling direction (Y) indicates a traveling direction of a satellite 101 or the like installed with the sensor, and a sensor scanning direction (X) 107 indicates a scanning direction of a data detecting unit of the sensor installed aboard the satellite or the like. In this example, the sensor includes only a single detecting unit. A detection direction 105 of the detecting unit is set forward and obliquely downward in the traveling direction, and the detecting unit performs scanning from left to right, as indicated by an X axis direction in FIG. 1, for example. In this case, sampling data observation points (109, 111, 113) obtained by the scanning are generally located in arcs, as shown in FIG. 1.

Heretofore, when data on a certain point between discrete points of the discrete data thus obtained is resampled on the basis of the discrete data, a nearest neighbor method has exclusively been used in order to keep a calculation amount within a reasonable extent (see Patent Document 1). (Here, if the calculation amount is not to be taken into account, it is not impossible to estimate physical quantity data on the certain position between discrete data by using rearranged data which is obtained by storing all the distorted data in arc shapes into a memory, and then correcting the distortion of the entire data to rearrange the data on orthogonal coordinates.)

However, in this nearest neighbor method, a data value actually obtained near a sampling point by the sensor is regarded to be equal to the sampling data value. For this reason, it has been difficult to estimate, by the nearest neighbor method, subtle changes in physical quantity data near a sampling point of the sensor.

A concept of dividing a group of observation points into triangular elements to create, for example, a bird's eye view on the basis of irregularly distributed geographical elevation information (a group of observation points) is known as a TIN (Triangulated Irregular Network). However, in the TIN, a triangle is formed by the closest three points in many cases, which often results in forming an extremely long and narrow triangle. This is not necessarily optimal in estimating, from a group of observation points, the elevation at a spot between observation points of the group. (If a long and narrow triangle is used, estimation of the elevation of a spot located within the narrow width is likely to be inaccurate due to a lack of information amount.) Moreover, there is also a problem that triangulation is not possible if four points surrounding a certain point are equally distant from the certain point, for example.

Patent Document 1; JP 2007-043461 A

### SUMMARY OF THE INVENTION

The field of remote sensing using a satellite has heretofore aimed at grasping a phenomenon in a global scale because of the characteristics of the satellite flying at an elevation of 100 km. Accordingly, remote sensing does not include an idea of grasping a phenomenon occurring in a local area almost as small as the resolution of a sensor.

In other words, it has been considered that taking the trouble to use a satellite is not needed to observe such a small area.

However, in order to catch a local phenomenon which may occur in any place, it is necessary to carry out observation in a global scale and also to find the tendency of a local area almost as small as the resolution of the sensor.

The present invention arises from such problems.

An object of the present invention is to facilitate estimation of subtle changes in physical quantity data near a sampling point of a sensor, which has been difficult to achieve by the nearest neighbor method and the TIN described above.

To achieve such an object, the following inventions are provided in the present patent application.

### (Invention 1)

A method of selecting six points from nine sampling points including a point (x,y)=(X,Y) as a center and its surrounding points and thereby estimating a Z-axis value of a certain point in six triangles obtained by the (X,Y) point and the six points, in which,

in such a coordinate system that, in a case where the nine sampling points on a substantially straight x axis and substantially straight y axes not orthogonal to each other are arranged on a single plane, the nine sampling points formed of three points (X−1, X, X+1) on each of the x axis and 3-discrete sampling points (Y−1, Y, Y+1) existing on each of the y axes intersecting respectively with the three points on the x axis, each of the sampling points has a certain value in a z-axis direction orthogonal to the plane, and thus each of the nine sampling points has 3-dimensional coordinate values of (X−1 or X+1, Y−1 or Y+1, Z−1 or Z+1),

each of the sampling points on (x,y) coordinates expresses a measurement target sampling point by a sensor, and the z-axis direction value of the (x,y) coordinates expresses a predetermined physical quantity Z at the point of the (x,y) coordinates, and

the x-axis direction points are sequentially set from past to present in accordance with an order of scanning by the sensor, and the y-axis direction points are substantially set from past to present in accordance with a traveling direction of the sensor, wherein

the method selects two points substantially on a diagonal of a rectangle defined by the outermost circumference of the nine points and forms the six triangles by six points excluding the two points, and

when an angle θ=(\vec{x}·\vec{y})/(|\vec{x}∥\vec{y}|) made between an x vector \vec{x} (parallel to the x axis) that has an initial point at the (X,Y) point and has a direction from past to present and a y vector \vec{y} (parallel to the y axes) that has an initial point at the (X,Y) point and has a direction from past to present, is θ>90°, the six triangles are formed of six points excluding two points on a diagonal in a direction of \vec{x}−\vec{y},

while, when θ≦90°, the six triangles are formed of six points excluding two points on a diagonal in a direction of \vec{x}+\vec{y}, and the Z-axis value of a predetermined point in the six triangles defined by the (x,y)=(X,Y) point and the six points is estimated on the basis of an equation of a plane formed of coordinates (X,Y,Z) of vertices of a triangle surrounding the predetermined point.

In the case of estimating a data value of a point within a region surrounded by three points which have actual measurement data, employing such a method achieves more accurate estimation of the data value by making the triangle formed by the three points as wide as possible.

### (Invention 2)

The method according to Invention 1, wherein the method uses a sensor for remote sensing using a satellite.

Employing such a method makes it possible, in remote sensing using a satellite, to observe a physical quantity on the earth in a global scale and to find a tendency of a local area close to the resolution of the sensor, which has never thought of before.

### (Invention 3)

A device for selecting six points from nine sampling points including a point (x,y)=(X,Y) as a center and its surrounding points and thereby estimating a Z-axis value of a certain point in six triangles obtained by the (X,Y) point and the six points, in which,

in such a coordinate system that, in a case where the nine sampling points on a substantially straight x axis and substantially straight y axes not orthogonal to each other are arranged on a single plane, the nine sampling points formed of three points (X−1, X, X+1) on each of the x axis and 3-discrete sampling points (Y−1, Y, Y+1) existing on each of the y axes intersecting respectively with the three points on the x axis, each of the sampling points has a certain value in a z-axis direction orthogonal to the plane, and thus each of the nine sampling points has 3-dimensional coordinate values of (X−1 or X+1, Y−1 or Y+1, Z−1 or Z+1),

each of the sampling points on (x,y) coordinates expresses a measurement target sampling point by a sensor, and the z-axis direction value of the (x,y) coordinates expresses a predetermined physical quantity Z at the point of the (x,y) coordinates, and

the x-axis direction points are sequentially set from past to present accordance with an order of scanning by the sensor, and the y-axis direction points are substantially set from past to present in accordance with a traveling direction of the sensor, the device comprising:

means for selecting two points substantially on a diagonal of a rectangle defined by the outermost circumference of the nine points and for forming the six triangles by six points excluding the two points, the means including
a unit of forming the six triangles by six points excluding two points on a diagonal in a direction of \vec{x}−\vec{y} when an angle θ=(\vec{x}·\vec{y})/(|\vec{x}∥\vec{y}|) made between an x vector \vec{x} (parallel to the x axis) that has an initial point at the (X,Y) point and has a direction from past to present and a y vector \vec{y} (parallel to the y axes) that has an initial point at the (X,Y) point and has a direction from past to present, is θ≧90°, and
a unit of forming the six triangles by six points excluding two points on a diagonal in a direction of \vec{x}+\vec{y} when θ≦90°; and

means for estimating the Z-axis value of a predetermined point in the six triangles defined by the (x,y)=(X,Y) point and the six points, on the basis of an equation of a plane formed of coordinates (X,Y,Z) of vertices of a triangle surrounding the predetermined point.

In the case of estimating a data value of a point within a region surrounded by three points which have actual measurement data, employing such a method achieves more accurate estimation of the data value by making the triangle formed by the three points as wide as possible.

### (Invention 4)

The device according to Invention 3, wherein the device uses a sensor for remote sensing using a satellite.

Employing such a device makes it possible, in remote sensing using a satellite, to observe a physical quantity on the earth in a global scale and to find a tendency of a local area close to the resolution of the sensor, which has never thought of before.

TABLE 1
Definitions of Terms Used in Present Description

| Term | Definition |
|---|---|
| Re-sampling | To estimate a data value assumed to have been obtained |
| (re-sample) | by measurement at an arbitrary point between |
| | measurement points, on the basis of data values of the |
| | measurement points. |
| Sampling points | Discrete points at each of which a sensor samples a |
| | physical quantity of a part targeted for sampling in an |
| | embodiment of the present invention. These points are |
| | arranged in 2-dimensions expressed by an X axis, a Y |
| | axis and the like to be described below. Incidentally, in |
| | the embodiment of the present invention, the physical |
| | quantity of each of these multiple sampling points is |
| | expressed by a Z-axis coordinate that is orthogonal to |
| | both the X axis and Y axis, and hence a 3-dimensional |
| | expression (X, Y, Z) is employed. |
| X axis | An axis in an arc formed by sampling points in a |
| | scanning direction, of a single scanning, of the sensor in |
| | the embodiment of the present invention. This X axis |
| | corresponds to the X axis in FIG. 3. The X axis may |
| | collectively be called x axes together with an (X − 1) axis |
| | and an (X + 1) axis to be described later. |
| Y axis | A substantially straight axis which is along a traveling |
| | direction of the sensor or substantially parallel to the |
| | direction, and is along sampling points, in the |
| | embodiment of the present invention. This Y axis |
| | corresponds to the Y axis in FIG. 3. The Y axis may |
| | collectively be called y axes together with a (Y − 1) axis and |
| | a (Y + 1) axis to be described later. |
| Central | A sampling point existing at the intersection of the |
| sampling point | above-described X axis and Y axis. This central |
| | sampling point corresponds to (X, Y) in FIG. 3. |
| (X − 1) axis | An axis that is substantially parallel to the X axis, and is |
| | along a scanning performed immediately before |
| | (performed in the past in terms of time compared with) |
| | that performed on the central sampling point on the Y |
| | axis, in the embodiment of the present invention. This |
| | (X − 1) axis corresponds to the (X − 1) axis in FIG. 3. The |
| | (X − 1) axis may collectively be called x axes together with |
| | the above-described X axis and the (X + 1) axis to be |
| | described later. |
| (X + 1) axis | An axis that is substantially parallel to the X axis, and is |
| | along a scanning performed immediately after |
| | (performed in the future in terms of time compared with) |
| | that performed on the central sampling point on the Y |
| | axis, in the embodiment of the present invention. This |
| | (X + 1) axis corresponds to the (X + 1) axis in FIG. 3. The |
| | (X + 1) axis may collectively be called x axes together with |
| | the above-described X axis and (X + 1) axis. |
| (Y − 1) axis | An axis that is substantially parallel to the Y axis, and |
| | passes a sampling point immediately before (which is a |
| | single sampling point in the past compared with) the |
| | central sampling point on the X axis, in the embodiment |
| | of the present invention. This (Y − 1) axis corresponds to |
| | the (Y − 1) axis in FIG. 3. The (Y − 1) axis may collectively |
| | be called y axes together with the above-described Y axis |
| | and the (Y + 1) axis to be described later. |
| (Y + 1) axis | An axis that is substantially parallel to the Y axis, and |
| | passes a sampling point immediately before (which is a |
| | single sampling point in the past compared with) the |
| | central sampling point on the X axis, in the embodiment |
| | of the present invention. This (Y + 1) axis corresponds to |
| | the (Y + 1) axis in FIG. 3. The (Y + 1) axis may collectively |
| | be called y axes together with the above-described Y axis |
| | and (Y − 1) axis. |
| Sensor traveling | In the embodiment of the present invention, the sensor |
| direction | can only sample a single point at a single time point, and |
| | the sensor samples sampling targets by performing |
| | scanning from left to right (or the other way round) in an |
| | obliquely downward direction in the traveling direction of |
| | the sensor while traveling. The “sensor traveling |
| | direction” is a direction in which the sensor travels in the |
| | embodiment of the present invention. |
| | This sensor traveling direction corresponds to the Y |
| | direction in FIG. 1, the y-axis direction in FIG. 2, and the |
| | Y-direction in FIG. 3. |
| Sensor scanning | In the embodiment of the present invention, the sensor |
| direction | can only sample a single point at a single time point, and |
| | the sensor samples sampling targets by performing |
| | scanning from left to right (or the other way round) in an |
| | obliquely downward direction in the traveling direction of |
| | the sensor while traveling. The “sensor scanning |
| | direction” is a direction in which the sensor performs |
| | scanning in the embodiment of the present invention. |
| | This sensor scanning direction corresponds to the X |
| | direction in FIG. 1 and the X axis direction in FIG. 2. |
| Intersection | An intersection (x, y) expresses, by coordinates on the X |
| (x, y) | axis and the Y axis, any one of nine intersections |
| | between the (X − 1) axis, the X axis, the (X + 1) axis, (Y − 1) |
| | axis, the Y axis and the (Y + 1) axis. |
| | The coordinates of the intersection of the X axis and the |
| | Y axis are set to be standard coordinates (X, Y). |
| | For example, at the intersection of the (X + 1) axis and the |
| | (Y − 1) axis, the “X + 1” axis corresponds to “Y + 1” on the Y |
| | axis, and the “Y − 1” axis corresponds to “X − 1” on the X |
| | axis, and hence |
| | (x, y) = (X − 1, Y + 1). |
| | See FIG. 3. |
| x vector | A vector that has its initial point at the central sampling |
| (parallel to X | point, is parallel to the X axis, and has such a direction |
| axis) \vec{x} | that an x coordinate value increases, in the embodiment |
| | of the present invention. |
| | See FIG. 3. |
| y vector | A vector that has its initial point at the central sampling |
| (parallel to Y | point, is parallel to the Y axis, and has such a direction |
| axis) \vec{y} | that a y coordinate value increases, in the embodiment of |
| | the present invention. |
| | See FIG. 3. |
| θ | An angle expressed as |
| | θ = (\vec{x} · \vec{y})/(\|\vec{x}\|\|\vec{y}\|) |
| | by using the above described x vector and y vector in the |
| | embodiment of the present invention. |
| Central point | An arbitrary vertex of a triangle surrounding a point * at |
| | which a physical quantity is desired to be estimated. |
| | This central point corresponds to (X, Y) in FIG. 3. |

According to the embodiment of the present invention, estimation of physical quantity data at an arbitrary point between sampling points of a sensor itself can be easily and accurately performed.

### BRIEF DESCRIPTION OF THE DRAWINGS

In the Drawings:

FIG. 1 shows a traveling direction of a satellite (sensor), a scanning direction of the sensor and observation points.

FIG. 2 shows the traveling direction, the scanning direction and a distribution of sampling points of the sensor.

FIG. 3 shows: an (X−1) axis, an X axis, an (X+1) axis, a (Y−1) axis, a Y axis and a (Y+1) axis; intersections of these axis (X−1, Y−1), (X, Y−1), (X+1, Y−1), (X−1, Y), (X, Y), (X+1, Y), (X−1, Y+1), (X, Y+1) and (X+1, Y+1), which are sampling points; and an angle θ between the X axis and the Y axis.

FIG. 4 illustrates expression of a measurement value as a point on a z axis.

FIG. 5 shows four measurement points surrounding a point * whose physical quantity is to be estimated, and a division example thereof (case 1).

FIG. 6 shows the four measurement points surrounding the point * whose physical quantity is to be estimated, and a division example thereof (case 2).

FIG. 7 shows a group of six intersections selectable from nine intersections surrounding a point (X,Y) when θ is an obtuse angle, and a group of six triangles defined by the selected intersections.

FIG. 8 shows a group of six intersections selectable from nine intersections surrounding a point (X,Y) when θ is an acute angle, and a group of six triangles defined by the selected intersections (case 1).

FIG. 9 shows a group of six intersections selectable from nine intersections surrounding a point (X,Y) when θ is an acute angle, and a group of six triangles defined by the selected intersections (case 2).

FIG. 10-A is a flowchart providing an outline of processing in an example of the present invention.

FIG. 10-B is a flowchart providing an outline of processing in an example of the present invention.

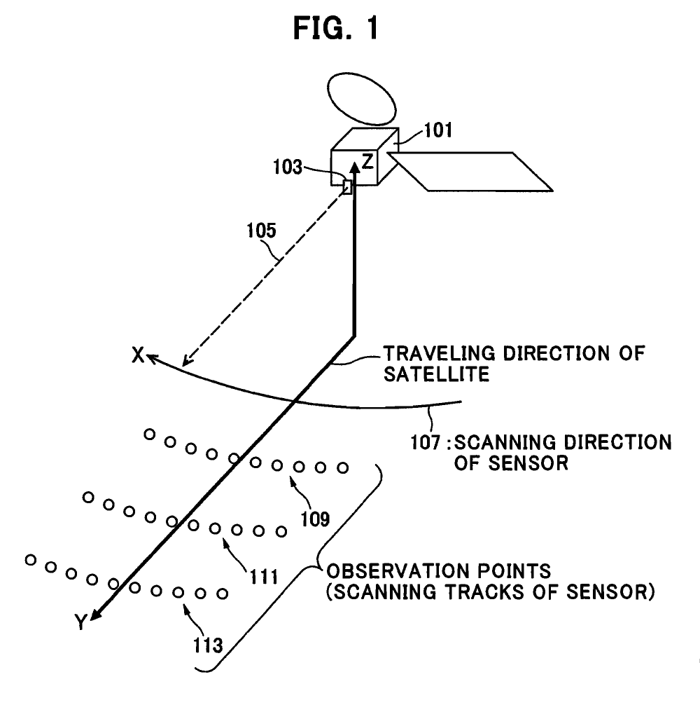

### DESCRIPTION OF THE PREFERRED EMBODIMENT

An embodiment of the present invention will be described below with reference to the drawings. It is to be noted that the following description is merely an illustration of the present invention and hence is not intended to limit the technical scope of the present invention.

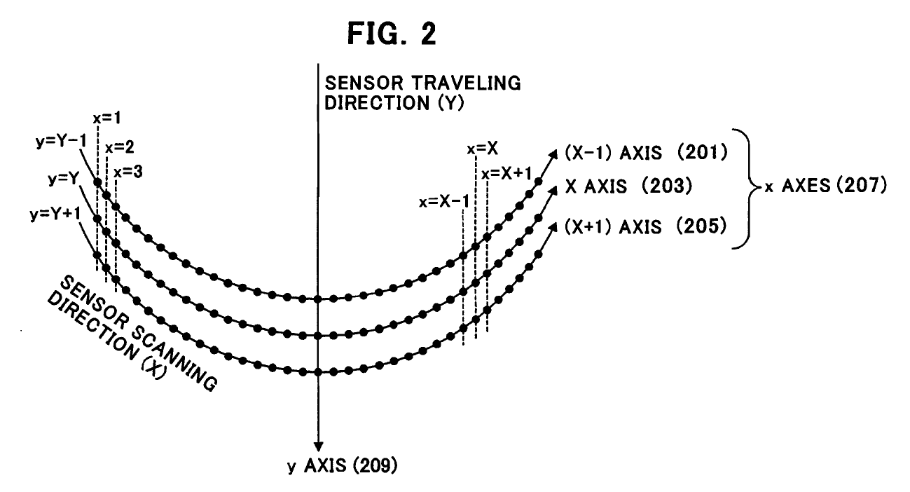

Refer to FIG. 2. FIG. 2 shows a traveling direction, a scanning direction and a distribution of sampling points of a sensor.

In FIG. 2, the sensor can only sample a single point at a single time point, and the sensor samples sampling targets by performing scanning from left to right (or the other way round) in an obliquely downward direction in the traveling direction of the sensor while traveling. A “sensor traveling direction (Y)” indicates the traveling direction of the sensor in the embodiment of the present invention. A “sensor scanning direction (X)” indicates a scanning direction of the sensor in the embodiment of the present invention.

In FIG. 2, three arc-shaped scanning lines are drawn. For the sake of simplicity, the central line is defined as an X axis (203), the line scanned before the scanning line on the X axis is defined as an (X−1) axis (201), and the line scanned after the scanning line on the X line is defined as an (X+1) axis (205). Incidentally, the X axis (203), the (X−1) axis (201) and the (X+1) axis (205) are collectively called x axes (207).

Moreover, in FIG. 2, the traveling directions of the sensor are called y axes (209). Then, the scanning line corresponding to the time point when y=Y−1 is the (X−1) axis (201), the scanning line corresponding to the time point when y=Y is the X axis (203), and the scanning line corresponding to the time point when y=Y+1 is the (X+1) axis (205).

Near the left edge of FIG. 2, broken lines corresponding to x=1, 2 and 3 are drawn. The coordinates of the intersections of the three broken lines with the (X−1) axis (201), the X axis (203) and the (X+1) axis (205) are:
for x=1, (1, Y−1), (1, Y) and (1, Y+1) in this order from the top;
for x=2, (2, Y−1), (2, Y) and (2, Y+1) in this order from the top; and
for x=3, (3, Y−1), (3, Y) and (3, Y+1) in this order form the top.

Near the right edge of FIG. 2, broken lines corresponding to x=X−1, X and X+1 are drawn. The coordinates of the intersections of the three broken lines with the (X−1) axis (201), the X axis (203) and the (X+1) axis (205) are:
for x=X−1, (X−1, Y−1), (X−1, Y) and (X−1, Y+1) in this order from the top;
for x=X, (X, Y−1), (X, Y) and (X, Y+1) in this order from the top;
for x=X+1, (X+1, Y−1), (X+1, Y) and (X+1, Y+1) in this order form the top.

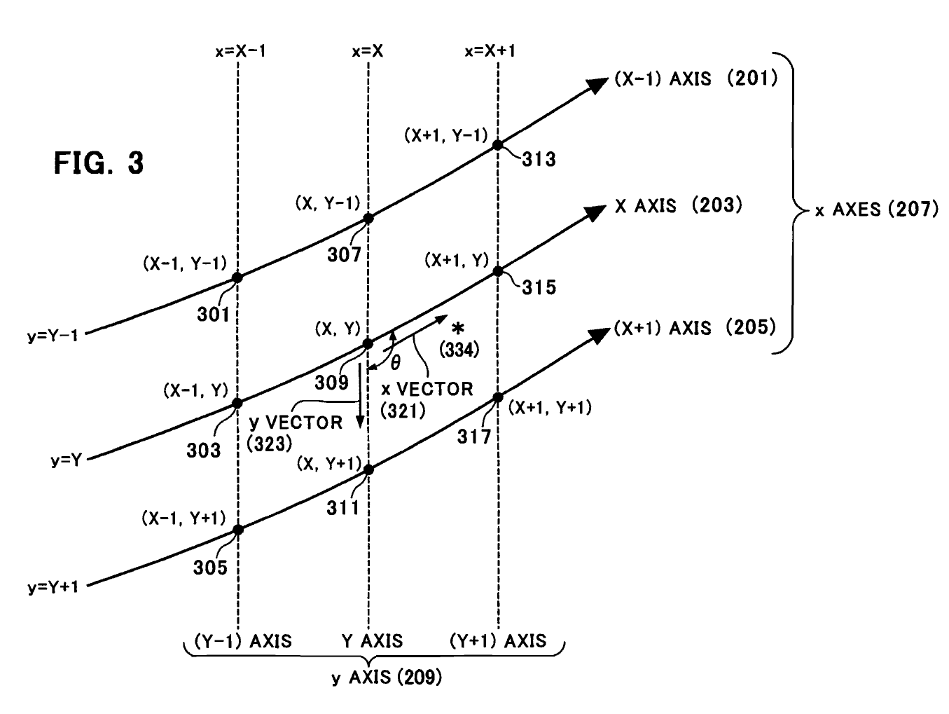

Next, refer to FIG. 3.

FIG. 3 is an enlarged view near the right edge of FIG. 2 where the broken lines corresponding to x=X−1, X and X+1 intersect with the solid lines corresponding to y=Y−1((X−1) axis), y=Y (X axis) and y=Y+1((X+1) axis).

Here, for the sake of simplicity, coordinates of the nine intersections of the three broken lines corresponding to x=X−1, X, X+1 with the (X−1) axis (201), the X axis (203) and the (X+1) axis (205) are designated as
(X−1, Y−1) (301), (X−1, Y) (303), (X−1, Y+1) (305),
(X, Y−1) (307), (X, Y) (309), (X, Y+1) (311),
(X+1, Y−1) (313), (X+1, Y)(315) and (X+1, Y+1) (317).

Furthermore, a vector that has its initial point at the central sampling point, is parallel to the X axis, and has such a direction that an x coordinate value increases, in the embodiment of the present invention is defined as an x vector 321 \vec{x} (parallel to the X axis), and a vector that has its initial point at the central sampling point, is parallel to the Y axis, and has such a direction that a y coordinate value increases, in the embodiment of the present invention is defined as a y vector 323 \vec{y} (parallel to the Y axis).

Then, an angle expressed by θ=(\vec{x}·\vec{y})/(|\vec{x}∥\vec{y}|) by using the above-described x vector and y vector is defined as θ.

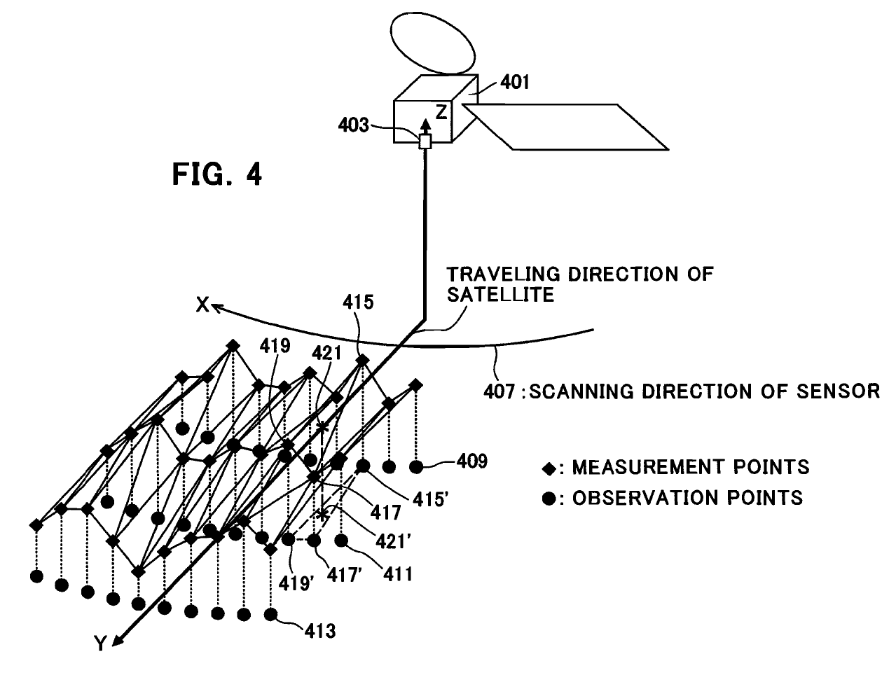

Now, refer to FIG. 4.

As shown in FIG. 4, in the embodiment of the present invention, measurement data (for example, temperature, humidity, atmospheric pressure, reflected light intensity or the like) value at each observation point is expressed as a value on a Z axis orthogonal to a plane defined by the X and Y axes.

As a result, when a series of measurements is finished, measurement values ♦ respectively at predetermined positions are plotted as shown by ♦ in FIG. 4, each position being above (or below) the corresponding observation point and being in a direction parallel to the Z axis, and a mountain-shaped profile having concaves and convexes is formed as a whole. Then, the plotted point of each measurement value ♦ forms a triangle with the nearest two other plotted points ♦ (for example, configured of three plots 415, 417 and 419). These three plotted points 415, 417 and 419 are respectively on Z axes of points 415′, 417′ and 419′ on the X−Y plane. In the embodiment of the present invention, an object is to estimate a physical quantity assumed to be measured at a position * (421′) in a triangle configured, for example, of the three plotted points 415′, 417′ and 419′, on the basis of actual measurement values of the three plots 415′, 417′ and 419′ (corresponding respectively to the Z-axis coordinate values of the plotted points 415, 417 and 419) surrounding the position * (421′).

For this estimation, an equation of a plane configured of the three points 415, 417 and 419 is obtained, and thereby a z-coordinate values corresponding to the x and y coordinate values of the point * is calculated on the plane, in the embodiment of the present invention.]

Return to FIG. 3 again.

In FIG. 3, the case of estimating a physical quantity at a point * (334) will be used as an example. In this case, as described with reference to FIG. 4, by considering a triangle including * (334), a physical quantity at * (334) is to be estimated on the basis of measurement values of the vertices of the triangle.

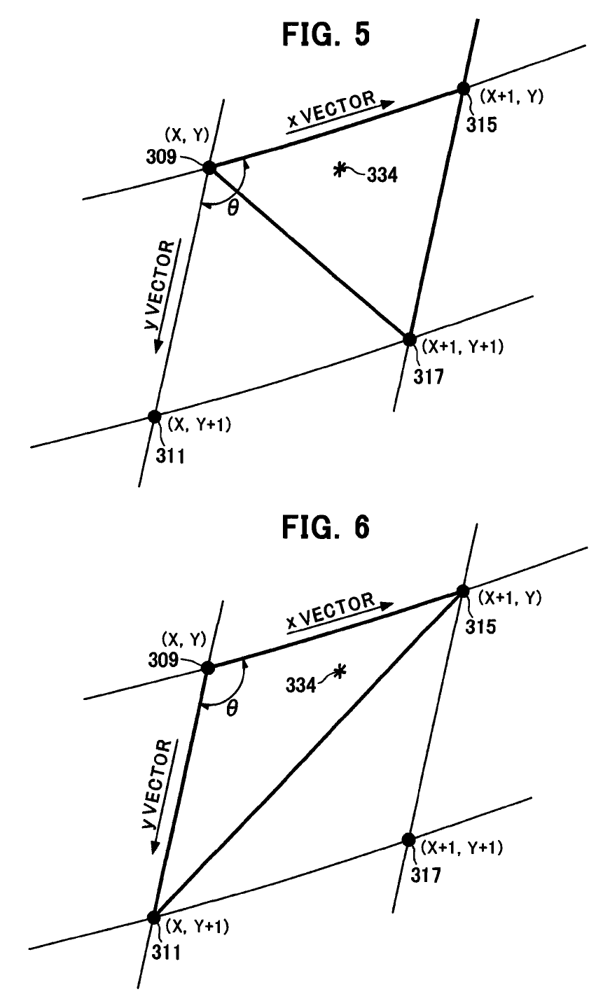

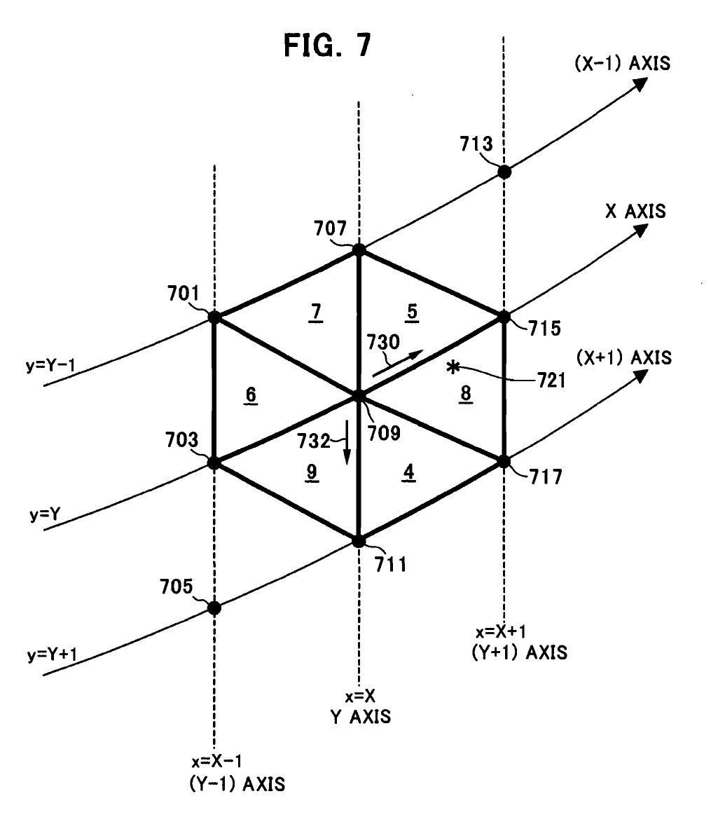

Here, there are two triangles each of which surrounds * (334): a triangle defined by 309, 315 and 317 as shown in FIG. 5; and a triangle defined by 309, 311 and 315 as shown in FIG. 6.

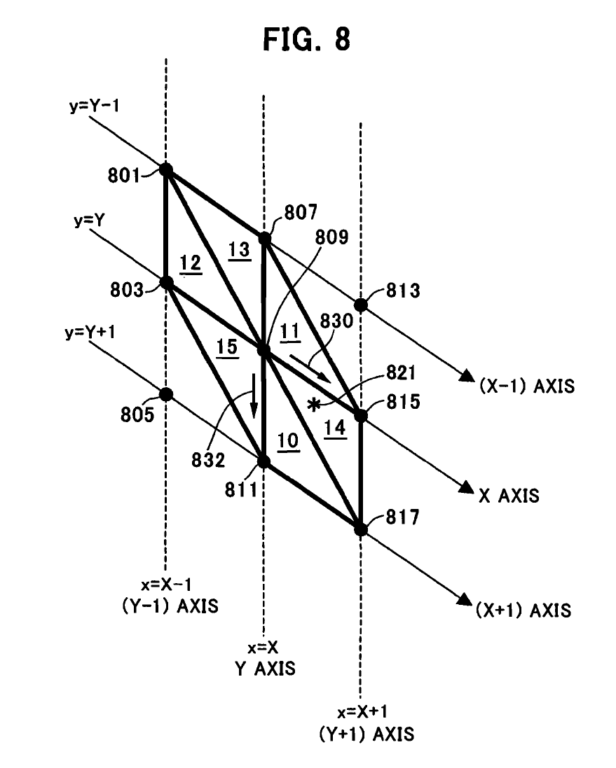

As can be seen by comparing FIG. 6 and FIG. 7, it is preferable to employ the triangle in FIG. 5 in order to more accurately estimate the physical quantity at * (334). This is because, if a long and narrow triangle is employed as that in FIG. 6, the estimation of the physical quantity at a point positioning within the narrow width is likely to be inaccurate due to the lack of information amount.

In the embodiment of the present invention, judgment in selecting a triangle is made on the basis of the size with the above-described angle θ.

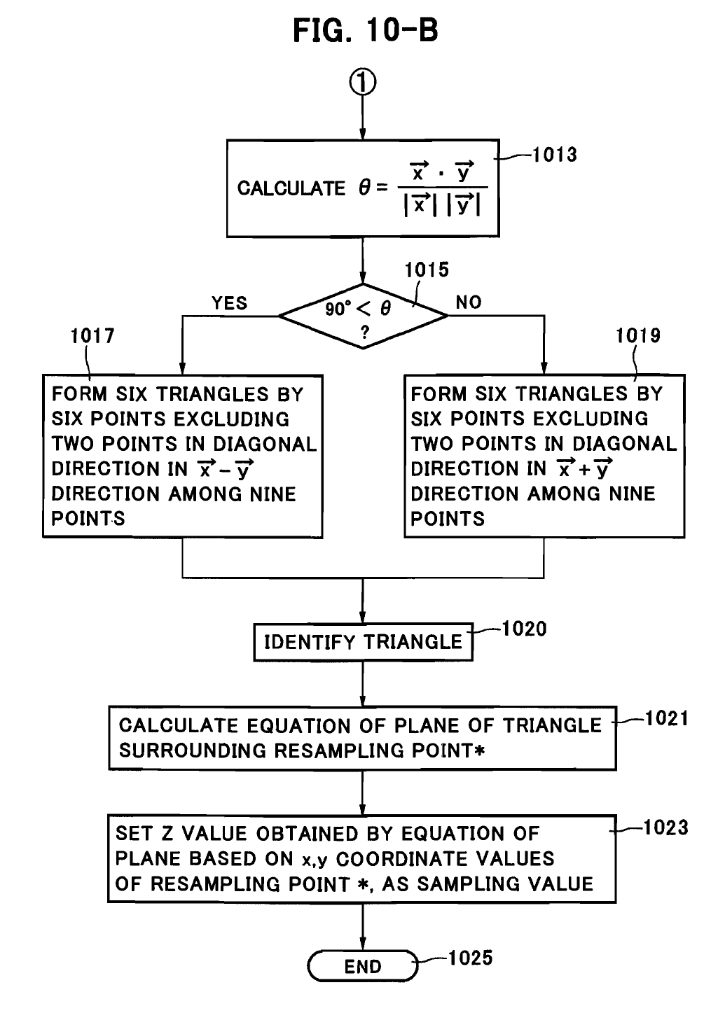

Detailed description will be given below. Refer to FIG. 7 as well as FIG. 10-A and FIG. 10-B (flowcharts).

First, in FIG. 10-A, a method of the present invention is started (1001).

Then, observation data are obtained respectively at observation points in a lattice distorted in the x-axis and y-axis directions, by a sensor installed aboard a satellite, for example (1003). Here, each observation data is evaluated as a value on the z axis orthogonal to both the x axis and the y axis, and the x, y and z coordinates are associated with each other and then stored in a storage means such as a memory.

Subsequently, after a triangle surrounding the point * (334) whose physical quantity is desired to be estimated is defined (1005), and an arbitrary one of the vertices of the triangle is defined as a central point (1007), the eight nearest sampling points surrounding the vertex are specified as sampling points (1009).

In the example in FIG. 7, nine points from 701 to 717 including the central point 709 are specified.

Thereafter, a vector that has its initial point at the central point, is parallel to the X axis, and has such a direction that an x coordinate value increases is defined as an x vector 730 \vec{x}, and a vector that has its initial point at the central sampling point, is parallel to the Y axis, and has such a direction that a y coordinate value increases is defined as a y vector 723 \vec{y} (1011).

Then, by using the above-described x vector and y vector, θ=(\vec{x}·\vec{y})/(|\vec{x}∥\vec{y}|) (equation 1) is calculated (1013 in FIG. 10-B), and if 90°<θ, six triangles are formed by six points (701, 703, 707, 709, 711, 715 and 717) excluding two points (705 and 713) in the diagonal direction in the direction of \vec{x}−\vec{y} among the above-described nine points (1017).

In the case in FIG. 7, since θ>90°, six triangles are formed by (701, 703, 707, 709, 711, 715 and 717).

Subsequently, a triangle surrounding a point * (721) whose physical quantity is desired to be estimated is specified among the group of triangles thus formed (1020). In the case in FIG. 7, the triangle numbered “8” (having 709, 715 and 717 as vertices) corresponds to the triangle to be specified.

Then, Z coordinates of these three vertices (709, 715 and 717) (observation values of the respective points: Z₇₀₉, Z₇₁₅ and Z₇₁₇) are searched for (these coordinates are obtained in advance by measurement, and the values thereof are stored in a predetermined memory or the like).

An equation of a plane including the coordinates (x,y,z) of the three vertices thus obtained, that is, (X,Y,Z₇₀₉), (X+1, Y,Z₇₁₅) and (X+1,Y+1,Z₇₁₇), is obtained by a known method (1021).

Then, a z-coordinate value Z₇₂₁ corresponding to * (721) is calculated by substituting the values of the (x,y) coordinates of * (721) in the equation of the plane, and is thereby estimated as the physical quantity of the point corresponding to the coordinates of * (721) (1023).

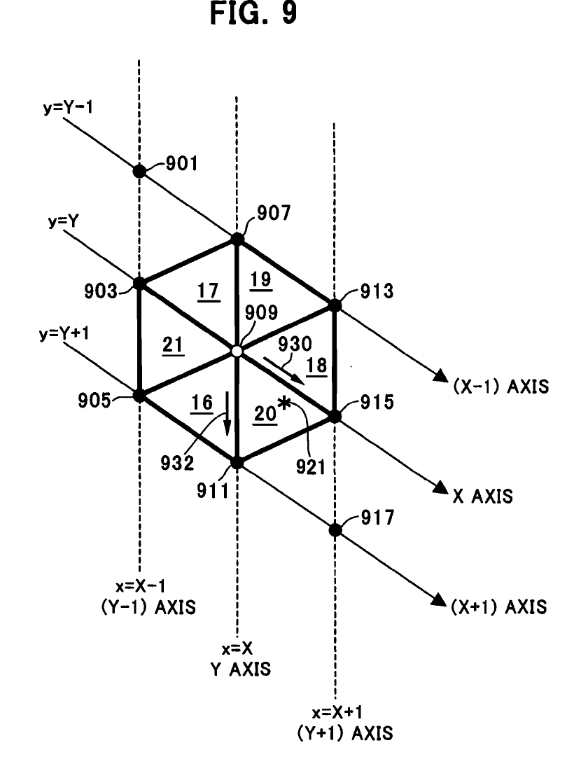

Next, refer to FIG. 8.

The same steps as in the case in FIG. 7 are performed until nine points from 801 to 817 including a central point 809 are specified.

However, in FIG. 8, θ calculated by the above equation 1 is θ≦90°.

In the embodiment of the present invention, when θ≦90°, six triangles are formed by six points excluding two points on the diagonal in the direction of \vec{x}+\vec{y} (1019).

This is because, as can be understood from FIG. 8 showing a hexagon excluding the two points (805 and 813) on the diagonal in the direction of \vec{x} −\vec{y}, the triangle including * (821) is extremely long and narrow in this case, and hence the estimation of the physical quantity at the point positioning within such a narrow width is likely to be inaccurate due to the lack of information amount.

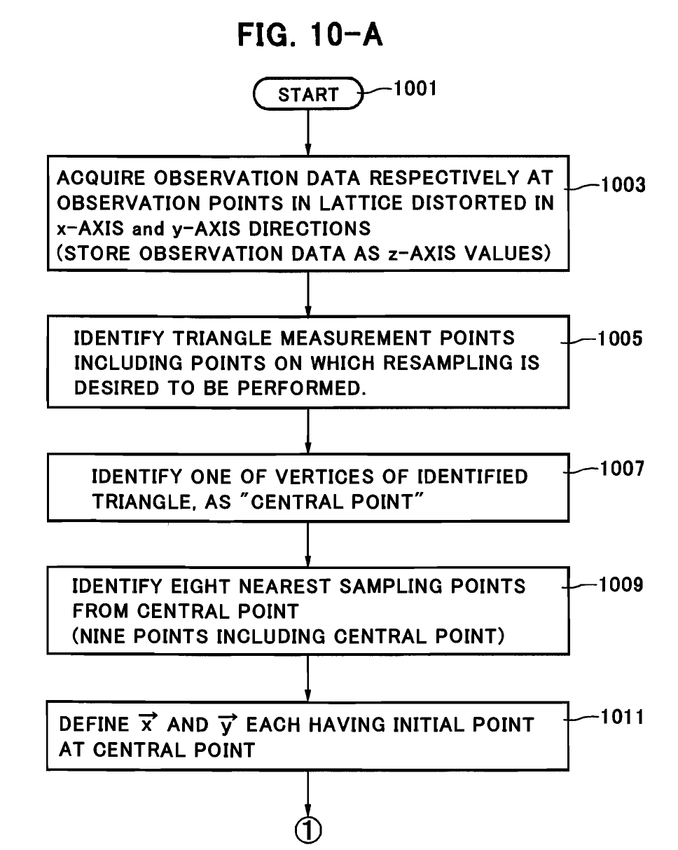

For this reason, in the example shown in FIG. 8, the six triangles are configured of the six points excluding the two points on the diagonal in the direction of \vec{x}+\vec{y}, and the result is shown in FIG. 9 (1019).

In FIG. 9, the same steps as described above are performed to obtain an equation of a plane of the triangle (configured of 909, 911 and 915) surrounding * (921) and thereby obtain the z coordinate at the point * (921) (1021 and 1023).

Incidentally, the invention according to each embodiment described above can be implemented, for example, by a computer including a CPU and a memory, or a sensor that is connected to the computer via a bus line and that can be monitored and controlled by the computer. Moreover, data obtained by the sensor is stored in the memory and is used in the subsequent processing. As the memory, various types such as a RAM, a ROM and a hard disk are employable, and the memory is not limited to anything particular as long as satisfying the object of the embodiment of the present invention.

### INDUSTRIAL APPLICABILITY

The invention according to the embodiment of the present invention is applicable to a wide field such as remote sensing using a satellite.

What is claimed is:

1. A method of selecting six points from nine sampling points including a point (x,y)=(X,Y) as a center and its surrounding points and thereby estimating a Z-axis value of a certain point in six triangles obtained by the (X,Y) point and the six points, in which,
in such a coordinate system that, in a case where the nine sampling points on a substantially straight x axis and substantially straight y axes not orthogonal to each other are arranged on a single plane, the nine sampling points formed of three points (X−1, X, X+1) on each of the x axis and 3-discrete sampling points (Y−1, Y, Y+1) existing on each of the y axes intersecting respectively with the three points on the x axis, each of the sampling points has a certain value in a z-axis direction orthogonal to the plane, and thus each of the nine sampling points has 3-dimensional coordinate values of (X−1 or X+1, Y−1 or Y+1, Z−1 or Z+1),
each of the sampling points on (x,y) coordinates expresses a measurement target sampling point by a sensor, and the z-axis direction value of the (x,y) coordinates expresses a predetermined physical quantity Z at the point of the (x,y) coordinates, and
the x-axis direction points are sequentially set from past to present in accordance with an order of scanning by the sensor, and the y-axis direction points are substantially set from past to present in accordance with a traveling direction of the sensor,
wherein the method selects two points substantially on a diagonal of a rectangle defined by the outermost circumference of the nine points and forms the six triangles by six points excluding the two points, and
when an angle θ=(\vec{x}·\vec{y})/(|\vec{x}∥\vec{y}|) made between an x vector \vec{x} (parallel to the x axis) that has an initial point at the (X,Y) point and has a direction from past to present and a y vector \vec{y} (parallel to the y axes) that has an initial point at the (X,Y) point and has a direction from past to present, is θ>90°, the six triangles are formed of six points excluding two points on a diagonal in a direction of \vec{x}−\vec{y},
while, when θ≦90°, the six triangles are formed of six points excluding two points on a diagonal in a direction of \vec{x}+\vec{y}, and the Z-axis value of a predetermined point in the six triangles defined by the (x,y)=(X,Y) point and the six points is estimated on the basis of an equation of a plane formed of coordinates (X,Y,Z) of vertices of a triangle surrounding the predetermined point.

2. The method according to claim 1, wherein the method uses a sensor for remote sensing using a satellite.

3. A device for selecting six points from nine sampling points including a point (x,y)=(X,Y) as a center and its surrounding points and thereby estimating a Z-axis value of a certain point in six triangles obtained by the (X,Y) point and the six points, in which,
in such a coordinate system that, in a case where the nine sampling points on a substantially straight x axis and substantially straight y axes not orthogonal to each other are arranged on a single plane, the nine sampling points formed of three points (X−1, X, X+1) on each of the x axis and 3-discrete sampling points (Y−1, Y, Y+1) existing on each of the y axes intersecting respectively with the three points on the x axis, each of the sampling points has a certain value in a z-axis direction orthogonal to the plane, and thus each of the nine sampling points has 3-dimensional coordinate values of (X−1 or X+1, Y−1 or Y+1, Z−1 or Z+1),
each of the sampling points on (x,y) coordinates expresses a measurement target sampling point by a sensor, and the z-axis direction value of the (x,y) coordinates expresses a predetermined physical quantity Z at the point of the (x,y) coordinates, and
the x-axis direction points are sequentially set from past to present in accordance with an order of scanning by the sensor, and the y-axis direction points are substantially set from past to present in accordance with a traveling direction of the sensor, the device comprising:
means for selecting two points substantially on a diagonal of a rectangle defined by the outermost circumference of the nine points and for forming the six triangles by six points excluding the two points, the means including
a unit of forming the six triangles by six points excluding two points on a diagonal in a direction of \vec{x}−\vec{y} when an angle θ=(\vec{x}·\vec{y})/(|\vec{x}∥\vec{y}|) made between an x vector \vec{x} (parallel to the x axis) that has an initial point at the (X,Y) point and has a direction from past to present and a y vector \vec{y} (parallel to the y axes) that has an initial point at the (X,Y) point and has a direction from past to present, is θ>90°, and
a unit of forming the six triangles by six points excluding two points on a diagonal in a direction of \vec{x}+\vec{y} when θ≦90°; and
means for estimating the Z-axis value of a predetermined point in the six triangles defined by the (x,y)=(X,Y) point and the six points, on the basis of an equation of a plane formed of coordinates (X,Y,Z) of vertices of a triangle surrounding the predetermined point.

4. The device according to claim 3, wherein the device uses a sensor for remote sensing using a satellite.
